(19) United States
(12) Patent Application Publication
(10) Pub. No.: US 2015/0359238 A1
(43) Pub. Date: Dec. 17, 2015

(54) POWDERY YOGHURT MATERIAL AND YOGHURT MAKING METHOD

(71) Applicant: NUTRITION ACT. CO., LTD., Tokyo (JP)

(72) Inventors: Hiromasa SUZUKI, Tokyo (JP); Masahito ISHIKAWA, Tokyo (JP); Yoko WATANABE, Tokyo (JP)

(21) Appl. No.: 14/835,682

(22) Filed: Aug. 25, 2015

Related U.S. Application Data
(63) Continuation of application No. PCT/JP2013/004054, filed on Jun. 28, 2013.

(30) Foreign Application Priority Data
Feb. 28, 2013 (JP) 2013-039636

(51) Int. Cl. A23C 9/123; A23C 21/06; A23C 9/127; A23C 9/13

(52) U.S. Cl. CPC A23C 9/123; A23C 9/13; A23C 9/1307; A23C 21/06; A23C 9/127; A23V 2002/00; A23Y 2220/00; A23Y 2320/00

(57) ABSTRACT

Provided are a yoghurt material for making a homemade yoghurt at home and a yoghurt making method using the yoghurt material. The powdery yoghurt material comprises: a milk powder and a lactic acid bacterium fermented at an ordinary temperature, wherein the powdery yoghurt material is converted into a yoghurt when the material to which water was added is fermented. The powdery yoghurt material further comprises a casein powder, an oligosaccharide and a propionic acid bacterium. The milk powder includes a whey as a main ingredient. Additionally, provided is a yoghurt making method using such a powdery yoghurt material.

### CROSS REFERENCE TO RELATED APPLICATION

The contents of the following Japanese patent application are incorporated herein by reference:
No. 2013-039636 filed on Feb. 28, 2013

### BACKGROUND

1. Technical Field

The present invention relates to a powdery yoghurt material and a yoghurt making method using the powdery yoghurt material.

2. Related Art

Conventionally, a powdery composition for yoghurt-like ready-to-eat dessert is known which allows general consumers to make ready-to-eat dessert at home quite easily by melting the same into milk or milk-like products at an ordinary temperature or a cool temperature or into water at an ordinary temperature or a cool temperature (for example, refer to Patent Literature 1).

Patent Literature 1 Japanese Patent Application Publication No. S58-183038

The powdery composition for yoghurt-like ready-to-eat dessert contains a powder, a fermented milk powder, a powder sweetener and an organic acid powder including an alpha starch, fat (Page 3, upper left column, line 9 to line 11), and particularly, contains about 5 to 30 wt % of an alpha starch (Page 3, lower left column, line 3 to line 5) such that is forms gelled substances in the form of yoghurt having tofu-like smooth and uniform tissues or tissues having numerous micropores (Page 3, upper right column, line 5 to line 9, and Page 2, lower left column, line 15 to lower right column, line 1). That is, the powdery composition for yoghurt-like ready-to-eat dessert was a material for coagulation provided with yoghurt-like flavors and textures (yoghurt-like product) as ready-to-eat dessert, but not a material in which a lactic acid bacterium is fermented and converted into “yoghurt.” Thus, the purpose of the present invention is to provide a powdery yoghurt material and a yoghurt making method which can solve the aforementioned problem.

### SUMMARY

Thus, in one aspect of the innovations included in this specification, the purpose is to provide a powdery yoghurt material and a yoghurt making method which can solve the aforementioned problem. The purpose is achieved by a combination of the features described in claims. That is, in the first aspect of the present invention, provided is a powdery yoghurt material comprising: a milk powder; and a lactic acid bacterium which ferments at an ordinary temperature, wherein the powdery yoghurt material is converted into a yoghurt when the material to which water was added is fermented. Additionally, provided is a yoghurt making method using such a powdery yoghurt material.

Note that all of the essential features of the present invention are not set forth in the summary of the aforementioned invention, but sub-combinations of a group of these features may also configure the invention.

### BRIEF DESCRIPTION OF THE DRAWINGS

FIG. 1 illustrates a yoghurt making method using a powdery yoghurt material according to this embodiment.

### DESCRIPTION OF EXEMPLARY EMBODIMENTS

Hereinafter, the present invention will be described through the embodiment of the invention. However, the following embodiment is not to limit the claimed invention, and all of the combinations of the features described in the embodiment are not necessarily essential for means for solving the problem of the invention.

The powdery yoghurt material according to this embodiment is provided to consumers, for example, in the form of a powder contained in containers such as plastic packages, and allows the consumers to add water for fermentation to make a homemade yoghurt.

The powdery yoghurt material according to this embodiment comprises a milk powder and a lactic acid bacterium. Furthermore, the powdery yoghurt material may comprise each of a milk protein, a casein powder, a sugar (for example, an oligosaccharide and the like) and a propionic acid bacterium. As one example, the powdery yoghurt material contains 20 to 60 wt % milk powder, 0.1 to 10 wt % lactic acid bacterium, 20 to 60 wt % casein powder, 0.1 to 10 wt % oligosaccharide, 0.1 to 10 wt % propionic acid bacterium and 0.1 to 10 wt % milk protein in ratio to 100 wt %. Note that the specific content of the milk powder, the lactic acid bacterium, the casein powder, the oligosaccharide, the propionic acid bacterium, and the milk protein may be varied as appropriate in consideration of flavors, coagulant effects, sweetness, intestinal regulation effects, textures and the like.

The milk powder may be a modified milk powder. The modified milk powder may contain 75 to 95 wt % non-fat milk solid, 0.1 to 0.5 wt % milk fat and 5 to 15 wt % plant fat in ratio to 100 wt %. As described above, the powdery yoghurt material does not contain a whole milk powder but contains a modified milk powder as the milk powder, thereby containing a reduced fat and thus enabling making an almost fat-free yoghurt. Note that, in this embodiment, the milk powder is not limited to a modified milk powder, but may be a milk, a processed milk, a whole milk powder, a defatted milk powder, a cream powder, a whey powder, a protein-condensed whey powder, a butter milk powder, a sweetened milk powder, and other powdery foods mainly made from a milk and the like.

As a lactic acid bacterium, strains which ferment at an ordinary temperature are used. The ordinary temperature is, for example, 35 degrees C. or lower, and more preferably, may be 30 degrees C. or lower. In addition, the lower limit of the fermentation temperature may be, as one example, 20 degrees C. or higher, or 25 degrees C. or higher. In this embodiment, a lactic acid bacterium is not particularly limited as long as being applicable as foods, but may be, for example, Streptococcus thermophilus, Lactobacillus acidophilus, Lactobacillus brevis, Lactobacillus buchneri, Lactobacillus casei, Lactobacillus delbrueckii, Lactobacillus fermentum, Lactobacillus helveticus, Lactobacillus kefir, Lactobacillus paracasei, Lactobacillus plantarum, Lactobacillus rhamnosus, Lactobacillus salivarius, Lactobacillus bulgaricus, Lactobacillus gasseri, Bifidobacterium bifidum, Bifidobacterium longum, Bifidobacterium adolescentis, Bifidobacterium breve, Bifidobacterium lactis, Bifidobacterium thermophilus, Lactococcus lactis, Lactococcus lactis subspecies cremoris, Lactococcus plantarum, Lactococcus raffinolactis, Leuconostoc lactis, Leuconostoc mesenteroides, Enterococcus faecalis, Enterococcus faecium and the like.

A casein powder provides a yoghurt with coagulant effects. Therefore, the powdery yoghurt material enables making an almost fat-free but rich yoghurt. Note that, if the aforementioned modified milk powder does not contain a casein, the amount of a casein powder may be adjusted such that coagulant effects of the yoghurt are adjusted. For example, when the amount of the casein powder is increased, the coagulant effects of the yoghurt are enhanced and the yoghurt of creamy finish can be made.

An oligosaccharide may be, as one example, a xylo-oligosaccharide. The xylo-oligosaccharide provides a yoghurt with sweetness. Therefore, the powdery yoghurt material enables making an easy-to-eat yoghurt. In addition, a xylo-oligosaccharide has an effect to increase good bacteria (for example, bifidobacteria and the like) within the intestine while inhibit increase of bad bacteria (for example, coli bacilli) within the intestine. Therefore, the powdery yoghurt material enables making a yoghurt having intestinal regulation effects. Note that, in this embodiment, an oligosaccharide is not limited to a xylo-oligosaccharide, but may be fruct-oligosaccharide, galacto-oligosaccharide, Lactosucrose, Lactulose, agaro-oligosaccharide, isomalto-oligosaccharide, sucrose, lactose, trehalose, maltose, raffinose, panose, maltotriose, melezitose, gentianose, stachyose, cyclodextrin and the like.

A propionic acid bacterium is selected from a group of suitable propionic acid bacteria, such as Propionibacterium freudenreichii, Propionibacterium acidifaciens, Propionibacterium acidipropionici, Propionibacterium acnes, Propionibacterium australiense, Propionibacterium avidum, Propionibacterium cyclohexanicum, Propionibacterium granulosum, Propionibacterium jensenii, Propionibacterium microaerophilum, Propionibacterium propionicum, Propionibacterium thoenii and the like, and as one example, may be a bacteria powder in which SI26 strains and SI41 strains are mixed. A propionic acid bacterium reaches the intestine while remains alive, and produces a propionic acid to increase bifidobacteria within the intestine. Therefore, the powdery yoghurt material containing a xylo-oligosaccharide and a propionic acid bacterium enables making a yoghurt with improved intestinal regulation effects. In addition, a propionic acid bacterium has a function to enhance absorption of minerals within the body. Therefore, when mineral water is used as water to be added to the powdery yoghurt material, a yoghurt can be made which allows for an efficient intake of minerals.

A milk protein has physical characteristics of binding with water, organizing and gelling, which inhibit isolation of water from a yoghurt. As described above, addition of the milk protein inhibits isolation of water from the yoghurt such that the yoghurt remains clean after a certain amount of time has passed since production (for example, 24 hours or more).

The aforementioned powdery yoghurt material may be, as one example, a powder in which a lactic acid bacterium and a propionic acid bacterium are mixed in granule containing a modified milk powder, a casein, a xylo-oligosaccharide, and a milk protein. The powder is packed, for example, in plastic film or aluminum package bags and the like in order to inhibit moisture absorption and oxidization for storage for a long period, for example, six months since production. As described above, the powdery yoghurt material can be stored for a longer period than the yoghurt. Therefore, consumers may prepare a desired amount of the yoghurt as desired such that they need to pay less attention to the storage life thereof than that of an ordinary yoghurt.

The powdery yoghurt material contains a casein powder and a modified milk powder such that it is converted into a yoghurt when the material to which water was added is fermented. Note that the temperature of water to be added to the powdery yoghurt material may be an ordinary temperature or a temperature in a room where people lead daily lives (hereinafter, room temperature). That is, the powdery yoghurt material enables making a yoghurt merely by fermenting the material at an ordinary temperature or room temperature to which non-heated water at an ordinary temperature or room temperature was added. Therefore, a homemade yoghurt can be conveniently made at home having no special equipment for making a yoghurt. That is, the powdery yoghurt material is provided to general consumers as a yoghurt material for a homemade yoghurt and used for making a homemade yoghurt at each home. Note that the powdery yoghurt material may also be provided to restaurants and the like as a yoghurt material for making a yoghurt at restaurants and the like, and used at each location for making a unique yoghurt of its own.

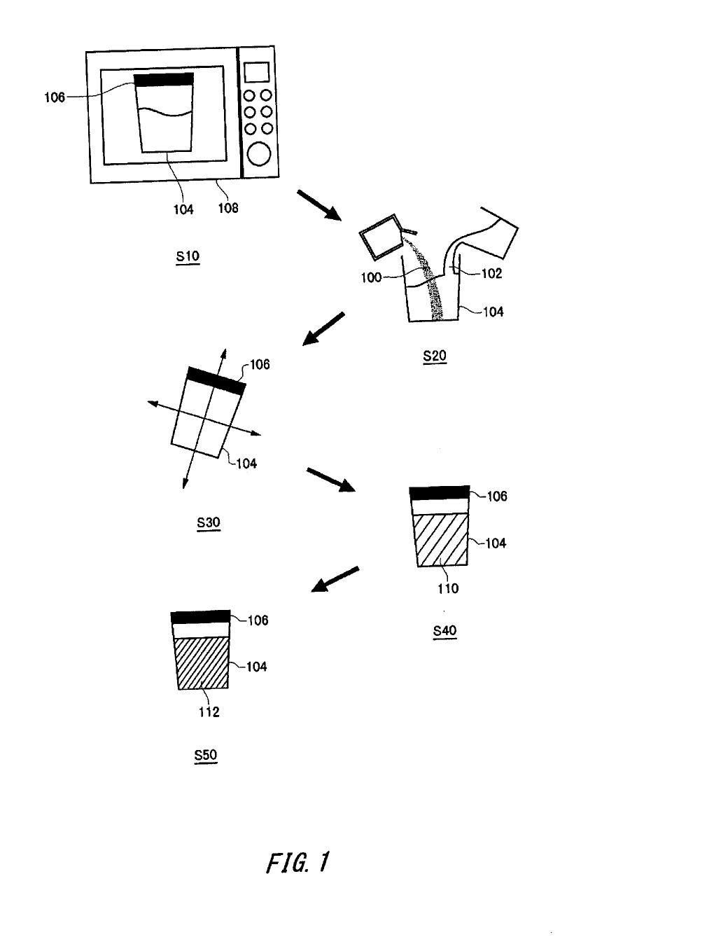

FIG. 1 illustrates one example of a yoghurt making method using the powdery yoghurt material according to this embodiment. First, prior to making a yoghurt, a yoghurt maker puts water in a container 104, closes it with a lid 106, and heats the container 104 in a microwave 108 in order to sterilize inside of the container 104 (S10). Note that, prior to making a yoghurt, the yoghurt maker may wash the container 104 with detergent in order to sterilize inside of the container 104, or the yoghurt maker may pour boiling water into the container 104 in order to sterilize inside of the container 104. Next, the yoghurt maker puts a powdery yoghurt material 100 and a water 102 in the container 104 (S20). As one example, the yoghurt maker opens an individually-packaged powdery yoghurt material 100 in the container 104, and adds a predefined standard amount of the water 102.

Next, the yoghurt maker closes the container 104 with the lid 106, and shakes the container 104 up and down and from side to side, for example, 20 times or more until the powdery yoghurt material 100 is completely dissolved or dispersed in the water 102 in order to prepare mixture 110 in which the powdery yoghurt material 100 is dissolved or dispersed in the water 102 (S30). Subsequently, the yoghurt maker ferments the mixture 110 at an ordinary temperature until the mixture 110 in the container 104 coagulates (S40). The fermentation time period may be 12 to 24 hours, and is typically, approximately 18 hours.

The fermentation time period depends on conditions of the temperature and the like. However, according to the making method of this embodiment, the fermentation time period of 12 to 18 hours, shorter than standard time period, enables making a smooth yoghurt with less sharpness and sourness, while the fermentation time period of 18 to 24 hours, longer than the standard time period, enables making a yoghurt with enhanced sharpness and sourness. Note that the lactic acid bacterium may also ferment at a temperature below 25 degrees C. In this case, the fermentation time period may be 24 to 48 hours, and is typically, approximately 36 hours. That is, the lactic acid bacterium ferments at room temperature.

The mixture 110 which has coagulated after the fermentation time period is converted into a yoghurt 112 (S50). As described above, according to the making method of this embodiment, mixing the powdery yoghurt material 100 and the water 102 and fermenting the mixture at an ordinary temperature or room temperature enable making the yoghurt 112. Therefore, the container 104 in which the yoghurt is to be made may not be provided with a power source for heating it up to a higher temperature than the ordinary temperature (for example, 40 degrees C. or higher). Note that, in the making method, a yoghurt making machine may be used which is provided with a heating function which keeps heating a container at a constant temperature. When the yoghurt making machine is used, the fermentation temperature is not fluctuated unlike the room temperature and the fermentation speed is stabilized such that the yoghurt maker makes a yoghurt with uniform flavors and textures.

Note that the yoghurt 112 made according to the making method may be cooled in a refrigerator. This stops fermentation of the yoghurt 112. In addition, the yoghurt maker may vary the amount of the water 102 to be added to the powdery yoghurt material 100 such that the yoghurt 112 is finished in a varied manner. For example, the yoghurt maker may add the larger amount of the water 102 to the powdery yoghurt material 100 than the standard amount in order to make a yoghurt of drinkable type.

In addition, in the embodiment, the description was given of the case in which the powdery yoghurt material to which water was added is fermented. However, the material to which a drink other than water was added may be fermented. For example, the powdery yoghurt material to which milk was added, instead of water, may be fermented. It may be selected which material to be fermented, the material to which water was added, or the material to which milk was added. For example, if the yoghurt maker dissolves or disperses the powdery yoghurt material in milk, a strong-flavored yoghurt like a cream cheese may be made. In addition, the powdery yoghurt material to which both of water and milk were added may be fermented.

In addition, in the embodiment, the description was given of the case in which a modified milk powder is employed as a milk powder. However, instead of a modified milk powder, a whole milk powder may be employed. In this case, the fat content of the powdery yoghurt material is not near zero. However, the yoghurt maker may make a yoghurt with a richer taste than when using the powdery yoghurt material containing a modified milk powder. As described above, if the powdery yoghurt material to which a drink other than water was added is fermented, or contains a whole milk powder as a milk powder, the yoghurt maker can make a yoghurt according to the making method similar to those in FIG. 1.

In addition, the yoghurt made according to the making method may be used as a skin care product, not only as a food. As one example, consumers add water or milk to the powdery yoghurt material to make a yoghurt, and apply the yoghurt to their skins. Thus, consumers apply the yoghurt containing a milk fat to their skins such that more fat is supplied to their skins, thereby enhancing moisturizing feeling on the skins. In addition, consumers may select either water or milk to be added to the powdery yoghurt material depending on condition of their skins.

In addition, in the embodiment, the description was given of the case in which the powdery yoghurt material comprises a modified milk powder, a casein, a xylo-oligosaccharide, a milk protein, a lactic acid bacterium, and a propionic acid bacterium. However, the powdery yoghurt material may further comprise a powder milk product, a sugar, a processed starch thickener, an acidulant, a flavoring and a colorant.

As described above, the present invention was described through the embodiment. However, the scope of the present invention is not limited to the scope of the embodiment. It is apparent for those skilled in the art that various modifications or improvements could be made to the embodiment. It is apparent from the appended claims that the embodiments including such modifications or improvements may also be within the scope of the present invention.

In the making method shown in the claims, specification and drawings, the order of each process of the operations, procedures, steps, stages and the like was not particularly specified in the manner such as “before”, “prior to”. In addition, unless an output of a previous process is used in a subsequent process, it should be appreciated that any order may be applicable. Even if “first”, “next” and the like are used for simplicity of explanations in the flow of the claims, specification and drawings, it is not intended to mean that the processes must be performed in the specified order.

What is claimed is:

1. A powdery yoghurt material comprising:
a milk powder; and
a lactic acid bacterium which ferments at an ordinary temperature,
wherein the powdery yoghurt material is converted into a yoghurt when the material to which water was added is fermented.

2. The powdery yoghurt material according to claim 1, wherein
the milk powder includes a whey as a main ingredient, and
the powdery yoghurt material further comprises a casein powder.

3. The powdery yoghurt material according to claim 1, further comprising an oligosaccharide.

4. The powdery yoghurt material according to claim 3, wherein the oligosaccharide is a xylo-oligosaccharide.

5. The powdery yoghurt material according to claim 1, further comprising a propionic acid bacterium.

6. The powdery yoghurt material according to claim 1, wherein it is selectable which material to be fermented, the material to which water was added or the material to which milk was added.

7. A yoghurt making method comprising:
putting the powdery yoghurt material according to claim 1 and at least one of water and milk in a container; and
fermenting the yoghurt material at an ordinary temperature in the container.

8. The yoghurt making method according to claim 7, further comprising, before putting the powdery yoghurt material and at least one of water and milk in the container, sterilizing inside of the container by putting water in the container, closing the container with a lid, and heating the container in a microwave.
